(19) United States
(12) Patent Application Publication
(10) Pub. No.: US 2008/0018636 A1
(43) Pub. Date: Jan. 24, 2008

(54) DRIVER CHIP, DISPLAY DEVICE AND METHOD OF REPAIR

(76) Inventor: Jong-Woong CHANG, Chungcheongnam-do (KR)

Correspondence Address: MACPHERSON KWOK CHEN & HEID LLP, 2033 GATEWAY PLACE, SUITE 400, SAN JOSE, CA, 95110, US

(21) Appl. No.: 11/770,368

(22) Filed: Jun. 28, 2007

(30) Foreign Application Priority Data
Jul. 18, 2006 (KR) 2006-66763

(51) Int. Cl. G06F 3/038

(52) U.S. Cl. 345/211; 345/204

(57) ABSTRACT

A drive chip for a display device includes an output buffer section and a dummy buffer section. The output buffer section outputs a data signal to a plurality of data lines formed in a display area of a display panel. The dummy buffer section is electrically connected to a repair section crossing an end portion of the data lines. The repair section is formed in a peripheral area surrounding the display area in a ring shape. Therefore, a data line defect may be easily repaired using the dummy buffer section built into the source driver chip.

### CROSS-REFERENCE TO RELATED APPLICATIONS

This application claims priority under 35 U.S.C. § 119 to Korean Patent Application No. 2006-66763, filed on Jul. 18, 2006 in the Korean Intellectual Property Office (KIPO), the contents of which are herein incorporated by reference in their entirety.

### BACKGROUND OF THE INVENTION

1. Field of the Invention

The present invention relates to a driver chip, a display device having the driver chip and a method for repairing the display device. More particularly, the present invention relates to a driver chip capable of repairing a line defect, a display device having the driver chip and a method of repairing the driver chip.

2. Description of the Related Art

Generally, a liquid crystal display (LCD) device includes a display panel that displays an image using the light transmittance ratio of liquid crystal molecules. A gate driving circuit and a source driving circuit are electrically connected to the display panel and output a gate signal and a data signal, respectively. The display panel includes a display area and a peripheral area. The display area includes a plurality of pixel sections formed thereon. The peripheral area surrounds the display area, and has the gate and data driving circuits disposed thereon. A plurality of data lines, a plurality of gate lines and a plurality of switching elements are formed in the display area. Each of the switching elements includes a gate electrode electrically connected to the gate line, a source electrode connected to the data line and a drain electrode spaced apart from the source electrode.

The gate and data lines and the switching elements are formed on a base substrate through a plurality of deposition processes and a plurality of etching processes, thereby forming the display panel. When a defect occurs during the etching processes, a line defect, in which the gate lines and the data lines are opened, may occur. Therefore, an additional repairing process that repairs the line defect may be performed to enhance a manufacturing yield of the display panel.

### SUMMARY OF THE INVENTION

According to one aspect of the present invention a driver chip for a display device provides the capability of easily repairing a line defect.

The present invention also provides a display device capable of easily repairing a line defect.

The present invention also provides a method for repairing a display device.

In one aspect of the present invention, a driver chip for a display device includes an output buffer section and a dummy buffer section. The output buffer section outputs a data signal to a plurality of data lines formed in the display area of the display panel. The dummy buffer section is electrically connected to a repair section crossing an end portion of the data lines. The repair section is formed in a peripheral area surrounding the display area in a ring shape.

In another aspect of the present invention, a display device includes a display panel, a first dummy buffer section, a first repair line section and a second repair line section. The display panel includes a display area having a plurality of data lines and a plurality of gate lines crossing each other, and a peripheral area surrounding the display area. The first dummy buffer section built into a first driver chip is directly mounted in the peripheral area. The first repair line section crosses a first end portion of the data lines. The first repair line section is electrically connected to the first dummy buffer section. The second repair line section crosses a second end portion of the data lines. The second repair line section is electrically connected to the first repair line section through the first dummy buffer section.

In still another aspect of the present invention, a display device includes a display panel, a source driving part, a first repair line section and a second repair line section. The display panel includes a display area with a plurality of gate lines and a plurality of data lines crossed with each other, and a peripheral area that surrounds the display area. The source driving part is directly mounted thereon. The source driving part includes a plurality of driver chips that output data signals to the data lines. The first repair line section crosses a first end portion of the data lines. The first repair line is electrically connected to a driver chip disposed at an end portion of the peripheral area. The second repair line section is electrically connected to the first repair line section through the driver chip. The second repair line section crosses a second end portion of the data lines.

In further still another aspect of the present invention, a display device includes a display panel, a source driving part, a first repair line section, and a second repair line section. The display panel includes a display area with a plurality of gate lines and a plurality of data lines crossed with each other, and a peripheral area that surrounds the display area. The source driving part includes a plurality of driver chips being directly mounted on the peripheral area. The driver chips outputs data signals to the data lines. The first repair line section crosses a first end portion of the data lines. The first repair line is electrically connected to a first driver chip and a second driver chip of the driver chips, respectively. The first and second driver chips are disposed adjacent to each other. The second repair line section is electrically connected to the first repair line section through the first and second driver chips. The second repair line section crosses a second end portion of the data lines.

In still another aspect of the present invention, in order to repair a display device, a first shorting section is formed by shorting a crossing portion between a first repair line and a first end portion of a defective data line. Here, the first repair line is electrically connected to an input terminal of a dummy buffer built into a source driver chip directly mounted on a display panel. A second shorting section is formed by shorting a crossing portion between a second repair line electrically connected to an output terminal of the dummy buffer, and a second end portion of the defective data line. A driving of the dummy buffer is enabled.

A display device having the driver chip and the method of the invention for repairing the display device, a data line defect may be easily repaired using the dummy buffer section built into the source driver chip.

### BRIEF DESCRIPTION OF THE DRAWINGS

The above and other advantages of the present invention will become readily apparent by reference to the following detailed description when considered in conjunction with the accompanying drawings, in which:

FIG. 1 is a plan view illustrating a display device according to an exemplary embodiment of the present invention;

FIG. 2 is an enlarged view illustrating a display device shown in FIG. 1;

FIG. 3 is a plan view illustrating a display device according to another exemplary embodiment of the present invention;

FIG. 4 is a schematic circuit diagram illustrating a dummy buffer section shown in FIG. 3;

FIG. 5 is a schematic diagram showing a method of repairing a display device shown in FIG. 1;

FIG. 6 is a plan view illustrating a display device according to another exemplary embodiment of the present invention;

FIG. 7 is an enlarged view illustrating a display device shown in FIG. 6;

FIG. 8 is a schematic circuit diagram illustrating a dummy buffer section shown in FIG. 7; and

FIG. 9 is a schematic diagram showing a method of repairing a display device shown in FIG. 6.

### DESCRIPTION OF THE EMBODIMENTS

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to cross-section illustrations that are schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Hereinafter, the present invention will be described in detail with reference to the accompanying drawings.

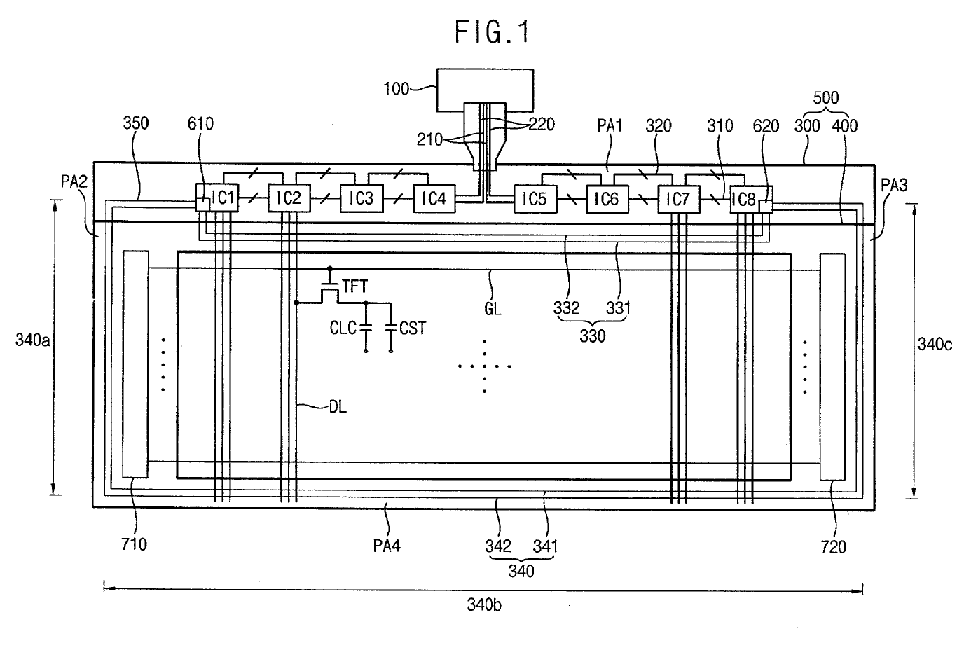

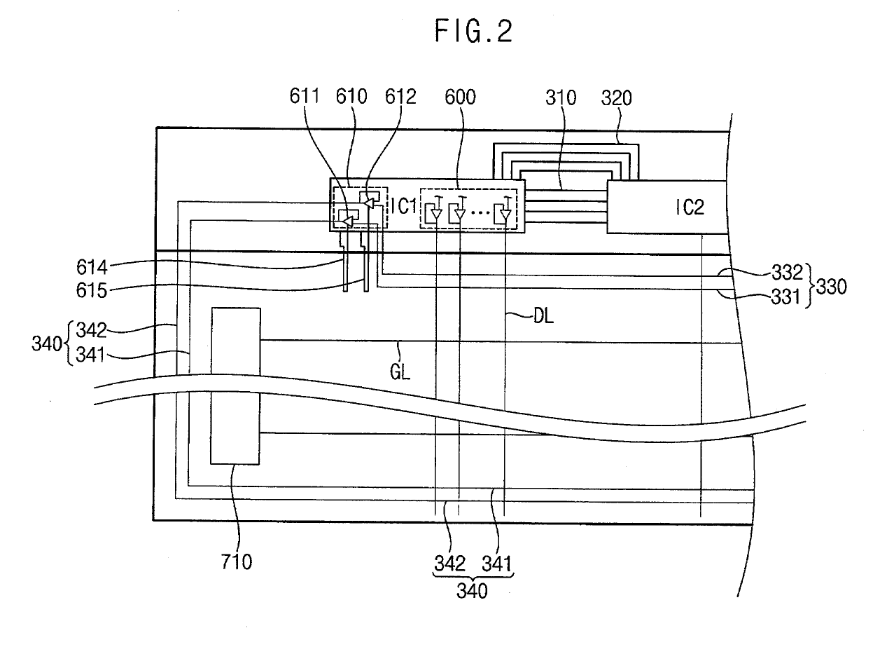

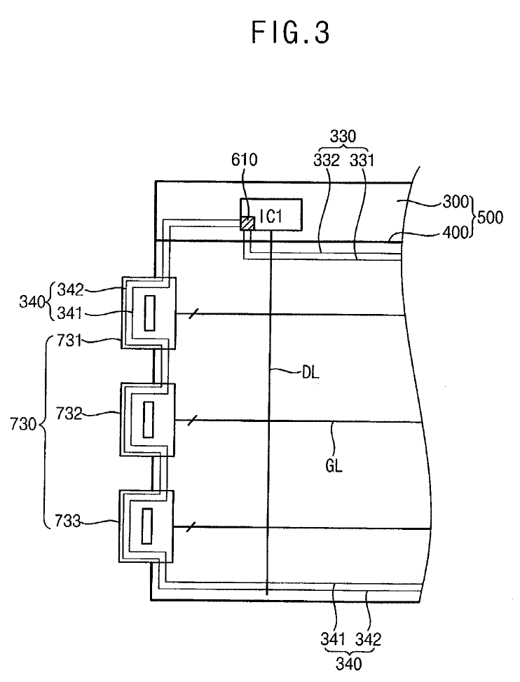

FIG. 1 is a plan view illustrating a display device according to an exemplary embodiment of the present invention. FIG. 2 is an enlarged view illustrating a display device shown in FIG. 1. FIG. 3 is a plan view illustrating a display device according to another exemplary embodiment of the present invention.

Referring to FIG. 1, a display device includes a printed circuit board (PCB) 100, a flexible PCB (FPCB) 200 and a display panel 500.

The PCB 100 has a main drive circuit (not shown) mounted thereon, and electrically connected to the FPCB 200. The FPCB 200 has a first line section 210 and a second line section 220 formed thereon, which are electrically connected to the PCB 100 and the display panel 500. The FPCB 200 may transfer a driving signal output from the main drive circuit to the display panel 500 through the first and second line sections 210 and 220.

The display panel 500 includes a display substrate 300, an opposite substrate 400 and a liquid crystal layer (not shown) interposed between the display substrate 300 and the opposite substrate 400. The display panel 500 includes a display area DA, a first peripheral area PA1, a second peripheral area PA2, a third peripheral area PA3 and a fourth peripheral area PA4. The first to fourth peripheral areas surround the display area DA.

A plurality of data lines DL and a plutality of gate lines GL are formed in the display area DA, so that the data and gate lines cross each other to define a plurality of pixel sections P. A switching element TFT, a liquid crystal capacitor CLC and a storage capacitor CST are formed in each of the pixel sections P.

A repair section 350 with a ring shape is formed in the first to fourth peripheral areas PA1, PA2, PA3 and PA4. The repair section 350 crosses two end portions of the data lines DL. The repair section 350 includes a first repair line section 330 and a second repair line section 340.

Particularly, a source driving part that outputs a data signal to the data line DL is formed in the first peripheral area PA1. The source driving part includes a first source driver chip IC1, a second source driver chip IC2, a third source driver chip IC3, a fourth source driver chip IC4, a fifth source driver chip IC5, a sixth source driver chip IC6, a seventh source driver chip IC7 and an eighth source driver chip IC8 that are directly mounted thereon. Each of the source driver chips includes an output buffer section 600 that outputs the data signal to the data line DL, respectively.

The first to fourth source driver chips IC1, IC2, IC3 and IC4 are mounted on a left portion of the first peripheral area PA1 when viewed from a plan view of the display device, and the fifth to eighth source driver chips IC5, IC6, IC7 and IC8 are mounted on a right portion of the first peripheral area PA1 when viewed from a plan view of the display device.

The first source driver chip IC1 mounted on the left portion has a first dummy buffer section 610 built into the first source driver chip IC1, and the eighth source driver chip IC8 mounted on the right portion has a second dummy buffer section 620 built into the eighth source driver chip IC8. The first dummy buffer section 610 may be used to repair when an open defect occurs in the data lines formed in the left portion, and the second dummy buffer 620 may be used to repair when an open defect occurs in the data lines formed in the right portion.

The first and second dummy buffer sections may be built into the first to eighth source driver chips IC1, IC2, IC3, IC4, IC5, IC6, IC7 and IC8, respectively.

A voltage line section 310 and a connection line section 320 are formed in the first peripheral area PA1. The voltage line section 310 and the connection line section 320 are formed between the source driver chips adjacent to each other, and carry a driving signal to the source driver chips through a cascade method. The voltage line section 310 carries a driving voltage to the source driver chip, and the connection line section 320 carries a data signal to the source driver chip.

The first repair line section 330 is formed in the first peripheral area PA1. The first repair line section 330 crosses a first end portion of the data lines DL. The first repair line section 330 is electrically connected to the first and second dummy buffer sections 610 and 620 that are built into the first and eighth source driver chips IC1 and IC8, respectively.

The second repair line section 340 is formed in the second, third and fourth peripheral areas PA2, PA3 and PA4, which is electrically connected to the first repair line section 330 through the first and second dummy buffer sections 610 and 620. The second repair line section 340 crosses a second end portion of the data lines DL.

Particularly, the second repair line section 340 includes a first portion 340a, a second portion 340b and a third portion 340c. The first portion 340a electrically connected to the first source driver chip IC1 is formed in the second peripheral area PA1. The second portion 340b crossed with the second end portion of the data lines DL is formed in the fourth peripheral area PA4. The third portion 340c electrically connected to the eighth source driver chip IC8 is formed in the third peripheral area PA3.

The first and second repair line sections 330 and 340 are electrically connected to each other through the first and second dummy buffer sections 610 and 620 in the first to fourth peripheral areas PA1, PA2, PA3 and PA4, thereby forming a ring shape.

Referring to FIG. 2, the first source driver chip IC1 includes an output buffer section 600 and a first dummy buffer section 610. The output buffer section 600 is electrically connected to the data line DL to output a data signal.

The first dummy buffer section 610 includes a first dummy buffer 611, a second dummy buffer 612, a first control line 614 and a second control line 615. For example, the first repair line section 330 includes a first repair line 331 and a second repair line 332, and the second repair line section 340 includes a third repair line 341 and a fourth repair line 342.

A first input terminal of the first dummy buffer 611 is electrically connected to the first repair line 331, and a first output terminal of the first dummy buffer 611 is electrically connected to the third repair line 341. A second input terminal of the second dummy buffer 612 is electrically connected to the second repair line 332, and a second output terminal of the second dummy buffer 612 is electrically connected to the fourth repair line 342.

The first control line 614 is electrically connected to a first power terminal of the first dummy buffer 611 to apply a driving voltage to the first dummy buffer 611. The second control line 615 is electrically connected to a second power terminal of the second dummy buffer 612 to apply a driving voltage to the second dummy buffer 612.

The second dummy buffer section 620 built into the eighth source driver chip IC8 is same as the first dummy buffer section 610. Thus, a detail description for the second dummy buffer section 620 will be omitted.

A gate driving part that outputs a gate signal to the gate line GL is formed in the second and third peripheral areas PA2 and PA3. For example, the gate driving part includes a first gate driving circuit 710 and a second gate driving circuit 720 that are directly integrated in the second and third peripheral areas PA2 and PA3. Hereinbefore, it is described that the first and second gate driving circuits 710 and 720 are formed in the second and third peripheral areas PA2 and PA3 that are two portions of the display area DA. Alternatively, the first and second gate driving circuits 710 and 720 are only formed in the second peripheral area PA2.

Referring to FIG. 3, the gate driving part 730 includes a first gate tape carrier package (TCP) 731, a second gate TCP 732 and a third gate TCP 733 that are mounted on the second peripheral area PA2. Here, the second repair line section 340 is formed in the second peripheral area PA2 via the first to third gate TCPs 731, 732 and 733.

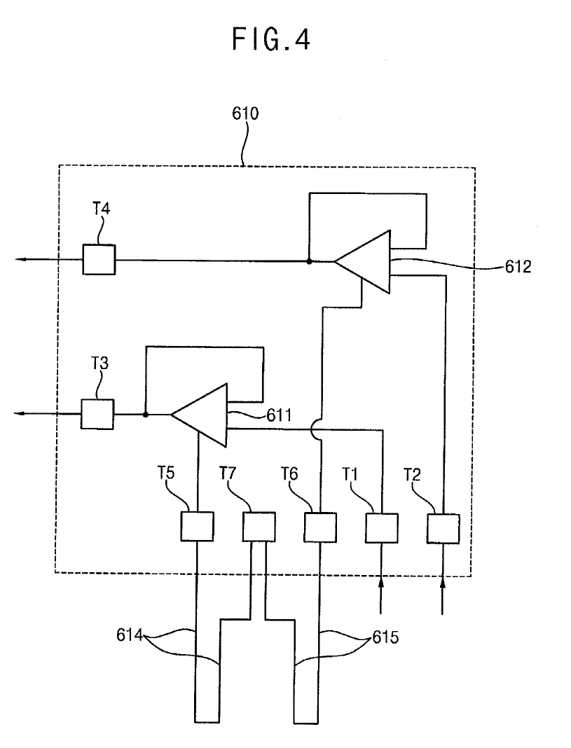

FIG. 4 is a schematic circuit diagram illustrating a dummy buffer section shown in FIG. 3.

Referring to FIGS. 3 and 4, a dummy buffer section 610 includes a first dummy buffer 611, a second dummy buffer 612, a first control line 614 and a second control line 615. A first input terminal T1 of the first dummy buffer 611 is electrically connected to the first repair line 331 to receive a data signal. A first output terminal T3 of the first dummy buffer 611 is electrically connected to the third repair line 341 to output a data signal amplified in the first dummy buffer 611 to the third repair line 341.

A second input terminal T2 of the second dummy buffer 612 is electrically connected to the second repair line 332 to receive a data signal. A second terminal T4 of the second dummy buffer 612 is electrically connected to the fourth repair line 342 to provide the fourth repair line 342 with a data signal amplified in the second dummy buffer 612.

The first control line 614 electrically connects to a first power terminal T5 of the first dummy buffer 611 and an external terminal T7 that receives a driving voltage from an external side. The second control line 615 electrically connects to a second power terminal T6 of the second dummy buffer 612 and the external terminal T6.

When the driving voltage is applied to the external terminal T7, the first and second dummy buffers 611 and 612 apply a driving voltage to the first and second power terminals T5 and T6 through the first and second control lines 614 and 615. Here, the first and second dummy buffers 611 and 612 may be disabled. When the first and second control lines 614 and 615 are electrically opened, a driving voltage is not applied to the first and second power terminals T5 and T6 of the first and second dummy buffers 611 and 612. Here, the first and second dummy buffers 611 and 612 may be disabled.

When the first and second dummy buffers 611 and 612 are enabled, the data signals input in the first and second input terminals T1 and T2 are amplified and output to the first and second output terminals T3 and T4.

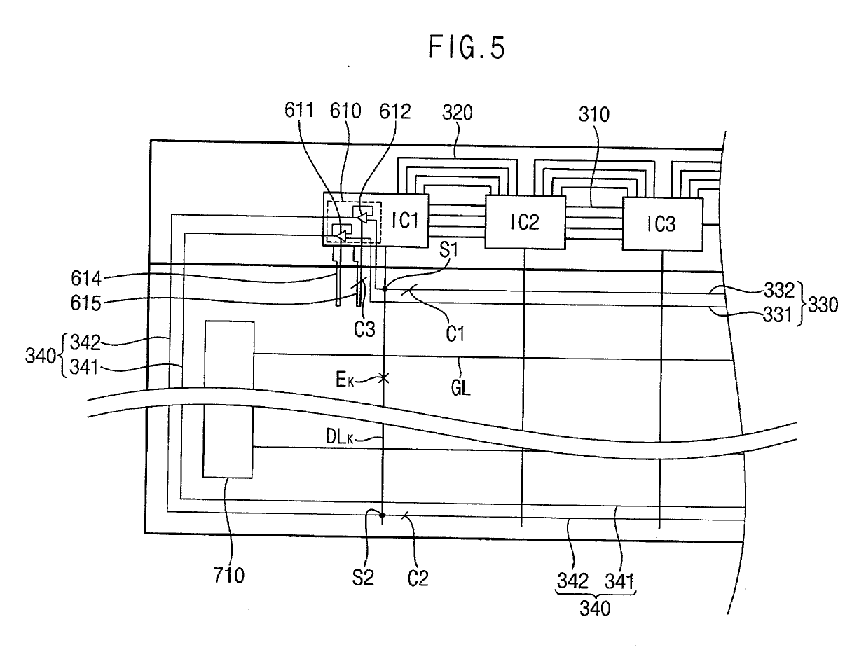

FIG. 5 is a schematic diagram showing a method of repairing a display device shown in FIG. 1.

Referring to FIGS. 1 and 5, when a K-th open defect E_{K} occurs in a K-th data line DL_{K} of the data lines formed in the display panel, a method that repairs the K-th data line DL_{K} is as follows.

Firstly, a shorting process is performed, which electrically shorts to the K-th data line DL_{K} and the first repair line section 330, and the K-th data line DL_{K} and the second repair line section 340.

A laser beam is applied in an overlapping portion between a first end portion of the K-th data line DL_{K} and the second repair line 332 to form a first shorting portion S1. A laser beam is applied in an overlapping portion between a second end portion of the K-th data line DL_{K} and the fourth repair line 342 to form a second shorting portion S2.

Then, in order to repair through the first dummy buffer section 610 adjacent to the K-th data line DL_{K} of the first and second dummy buffer sections 610 and 620, a cutting process is performed as follows.

A portion of the second repair line 332 is cut to form a first cutting portion C1, which connects to the first shorting portion S1 and the second dummy buffer portion 620. The first cutting portion C1 and the second dummy buffer portion 620 are electrically opened through the first cutting portion C1. A portion of the fourth repair line 342 is cut to form a second cutting portion C2, which is formed between the first cutting portion C1 and the second shorting portion S2.

The second cutting portion C2 and the second dummy buffer portion 620 are electrically opened through the second cutting portion C2. The K-th data line DL_{K} is electrically connected to the first dummy buffer portion 610 through the first and second shorting portions S1 and S2.

Then, the second dummy buffer 612 of the first dummy buffer section 610 is enabled, which is electrically connected to the second repair line 332 and the fourth repair line 342.

The second control line 615 is cut to form a third cutting portion C3, which applies a driving voltage to the second dummy buffer 612. The second dummy buffer 612 is disabled when the driving voltage is applied thereto, and is enabled when the driving voltage is insulated therefrom.

As the driving voltage, which is applied to the second dummy buffer 612 through the second control line 615, is insulated through the third cutting portion C3, the second dummy buffer 612 is enabled. The data signal input through the second repair line 332 is amplified to a predetermined level in the second dummy buffer 612, and then the amplified data signal is output to the fourth repair line 342.

As a result, a data signal output from the first source driver chip IC1 is applied to the K-th data line DL_{K} formed in a relatively upper portion of the K-th open defect E_{K}. In the mean time, the data signal output from the first source driver chip IC1 is input to the second dummy buffer 612 through the first shorting portion S1 to amplify to a predetermined level, and then applied to the K-th data line DL_{K} formed in a relatively upper portion of the K-th open defect E_{K} through the fourth repair line 342 formed in the second peripheral area PA2 and the second shorting portion S2 formed in the fourth peripheral area PA4.

Therefore, the data signal is regularly applied to the K-th data line DL_{K} having an open defect. According to the repairing method, a total number of four data lines may be repaired.

Hereinafter, the same reference numerals will be used to refer to the same or like parts as those described in the above-explained embodiment and any further repetitive explanation concerning the above elements will be omitted.

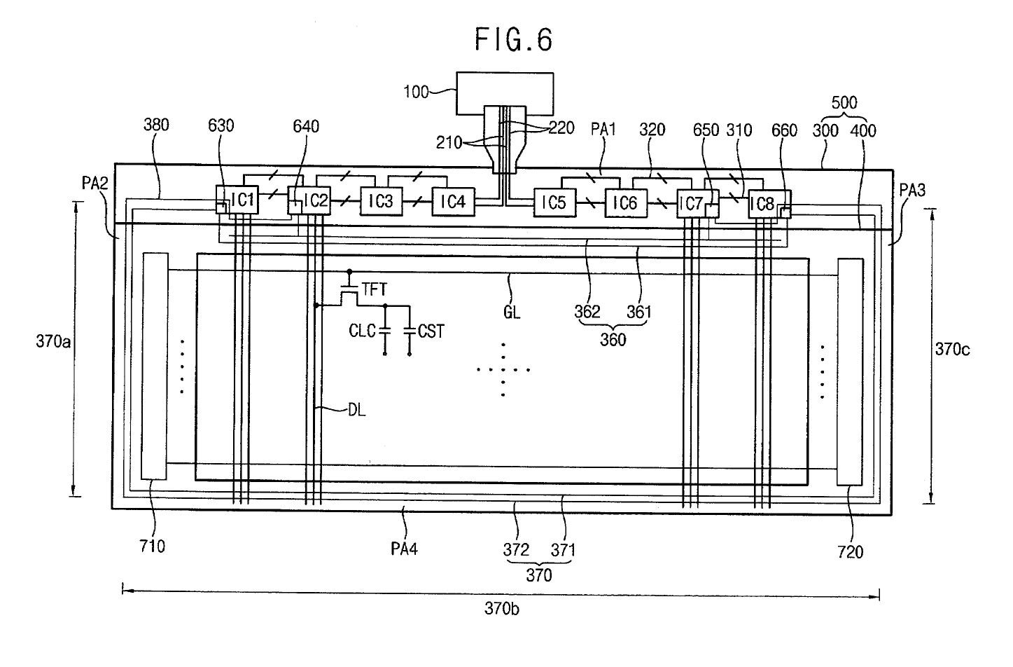

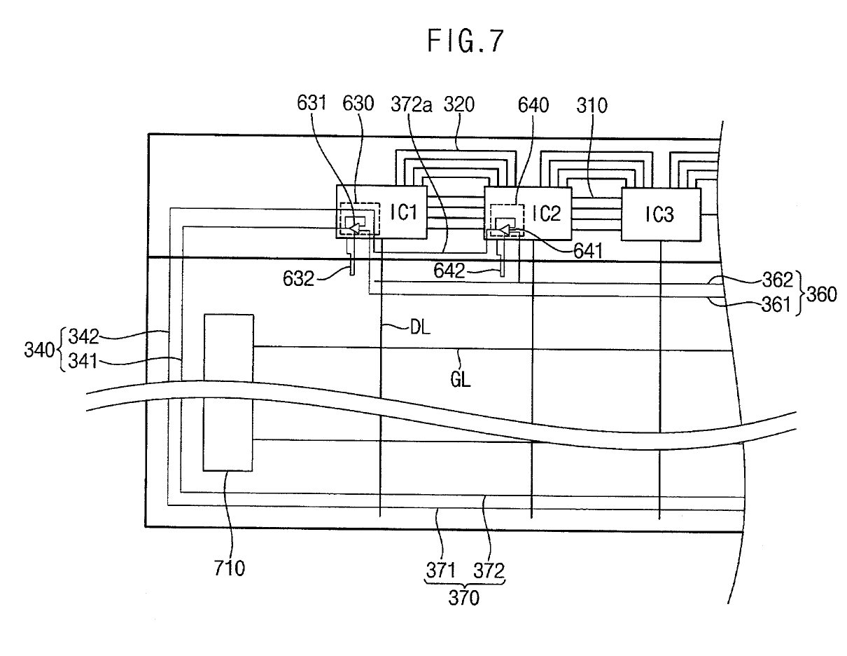

FIG. 6 is a plan view illustrating a display device according to another exemplary embodiment of the present invention. FIG. 7 is an enlarged view illustrating a display device shown in FIG. 6.

Referring to FIG. 6, a display panel 500 includes a display area DA and a plurality of peripheral areas that surrounds the display area DA. The peripheral areas include a first peripheral area PA1, a second peripheral area PA2, a third peripheral area PA3 and a fourth peripheral area PA4.

A repair section 380 formed in a ring shape is formed in the first to fourth peripheral areas PA1, PA2, PA3 and PA4, which crosses two end portions of the data lines DL. The repair section 380 includes a first repair line section 360 and a second repair line section 370.

Particularly, a source driving part that outputs a data signal to the data line DL is formed in the first peripheral area PA1. The source driving part includes a first source driver chip IC1, a second source driver chip IC2, a third source driver chip IC3, a fourth source driver chip IC4, a fifth source driver chip IC5, a sixth source driver chip IC6, a seventh source driver chip IC7 and an eighth source driver chip IC8 that are directly mounted on the first peripheral area PA1. Each of the source driver chips includes an output buffer section (not shown) that outputs the data signal to the data line DL, respectively.

The first to fourth source driver chips IC1, IC2, IC3 and IC4 are mounted on a left portion of the first peripheral area PA1 when viewed from a plan view of the display device, and the fifth to eighth source driver chips IC5, IC6, IC7 and IC8 are mounted on a right portion of the first peripheral area PA1 when viewed from a plan view of the display device. Each of the first and second source driver chips IC1 and IC2 mounted on the left portion has first and second dummy buffer sections 630 and 640, respectively, which are built into the first and second source driver chips IC1 and IC2. Each of the seventh and eighth source driver chips IC7 and IC8 mounted on the right portion has a third and fourth dummy buffer sections 650 and 660, respectively, which are built into the seventh and eighth source driver chips IC7 and IC8.

The first to fourth dummy buffer sections may be built into the first to eighth source driver chips IC1, IC2, IC3, IC4, IC5, IC6, IC7 and IC8, respectively.

The first repair line section 360 is formed in the first peripheral area PA1. The first repair line section 360 crosses a first end portion of the data lines DL. The first repair line section 360 includes a first repair line 361 and a second repair line 362 that are electrically connected to the first to fourth dummy buffer sections 630, 640, 650 and 660.

The second repair line section 370 is formed in the second, third and fourth peripheral areas PA2, PA3 and PA4, which is electrically connected to the first repair line section 360 through the first to fourth dummy buffer sections 630, 640, 650 and 660. The second repair line section 370 crosses a second end portion of the data lines DL. The second repair line section 370 includes a third repair line 371 electrically connected to the first repair line 361 and a fourth repair line 372 electrically connected to the second repair line 362.

Referring to FIG. 7, the first dummy buffer section 630 includes a first dummy buffer 631 and a first control line 632, and the second dummy buffer section 640 includes a second dummy buffer 641 and a second control line 642.

A first input terminal of the first dummy buffer 631 is electrically connected to the first repair line 361, and a first output terminal of the first dummy buffer 631 is electrically connected to the third repair line 371. A second input terminal of the second dummy buffer 641 is electrically connected to the second repair line 362, and a second output terminal of the second dummy buffer 641 is electrically connected to the fourth repair line 372. Here, the fourth repair line 372 includes a bridge line 372a that electrically connects to a second output terminal of the second dummy buffer 641 and the first source driving chip IC1.

The first control line 632 is electrically connected to a first power terminal of the first dummy buffer 631 to apply a driving voltage to the first dummy buffer 631. The second control line 642 is electrically connected to a second power terminal of the second dummy buffer 641 to apply a driving voltage to the second dummy buffer 641.

The third and fourth dummy buffer sections 650 and 660 built into the seventh and eighth source driver chips IC7 and IC8 is same as the first and second dummy buffer sections 630 and 640. Thus, a detail description for the third and fourth dummy buffer sections 650 and 660 will be omitted.

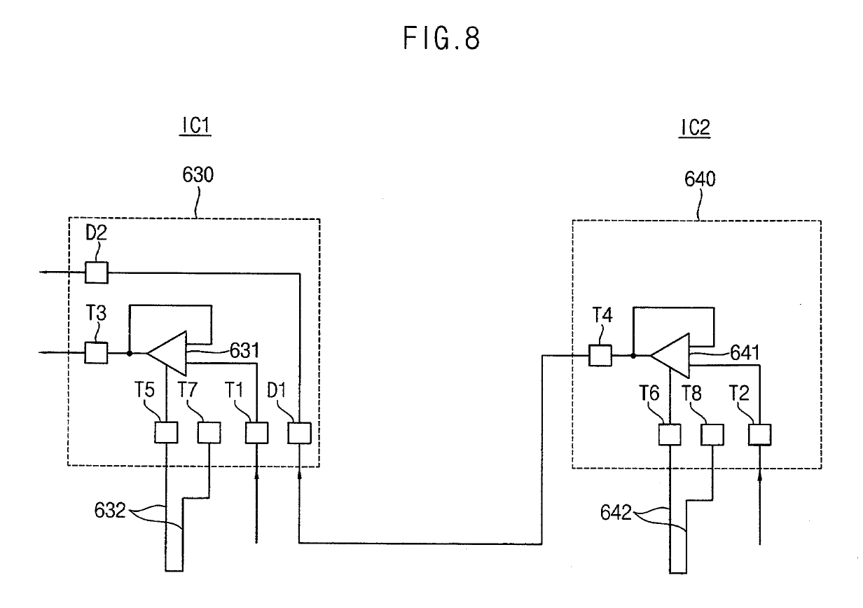

FIG. 8 is a schematic circuit diagram illustrating a dummy buffer section shown in FIG. 7.

Referring to FIGS. 7 and 8, a first dummy buffer section 630 includes a first dummy buffer 631 and a first control line 632, and a second dummy buffer section 640 includes a second dummy buffer 641 and a second control line 642.

A first input terminal T1 of the first dummy buffer 631 is electrically connected to the first repair line 361 to receive a data signal. A first output terminal T3 of the first dummy buffer 631 is electrically connected to the third repair line 371 to output a data signal amplified in the first dummy buffer 631 to the third repair line 371.

A second input terminal T2 of the second dummy buffer 642 is electrically connected to the second repair line 362 to receive a data signal. A second terminal T4 of the second dummy buffer 641 is electrically connected to the bridge line 372a of the fourth repair line 372 to provide the fourth repair line 372 with a data signal amplified in the second dummy buffer 641. The amplified data signal is carried to the fourth repair line 372 via the first dummy buffer section 630.

The first control line 632 electrically connects to a first power terminal T5 of the first dummy buffer 631 and a first external terminal T7 that receives a driving voltage from an external side. The second control line 642 electrically connects to a second power terminal T6 of the second dummy buffer 641 and a second external terminal T8 that receives a driving voltage from an external side.

When the driving voltage is applied to the first and second external terminals T7 and T8, the first and second dummy buffers 631 and 642 apply a driving voltage to the first and second power terminals T5 and T6 through the first and second control lines 632 and 642. Here, the first and second dummy buffers 631 and 642 may be disabled. When the driving voltage is not applied to the first and second dummy buffers 631 and 541 by electrically opening the first and second control lines 632 and 642, the first and second dummy buffers 631 and 641 are disabled.

That is, when the first and second dummy buffers 631 and 641 are enabled, the data signals that are input in the first and second input terminals T1 and T2 are amplified and output to the first and second output terminals T3 and T4.

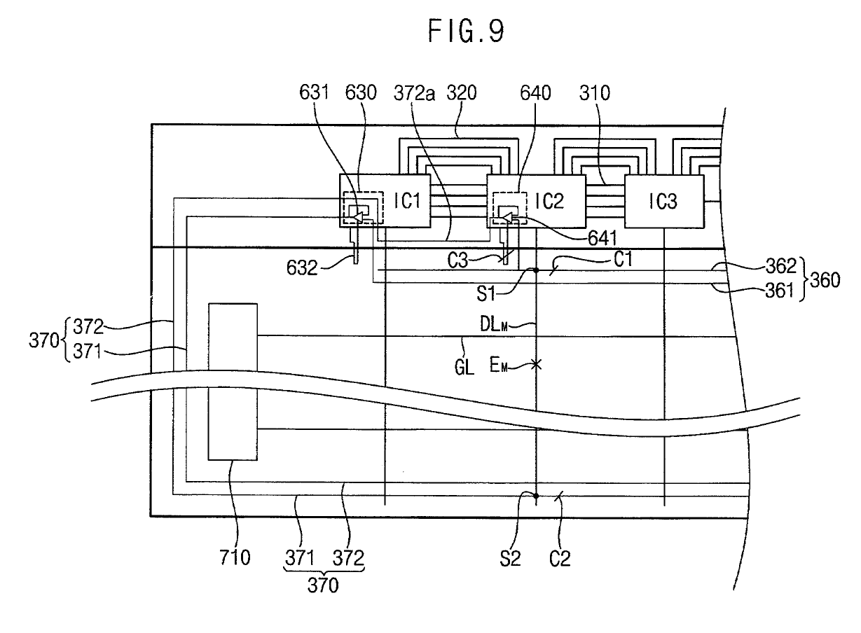

FIG. 9 is a schematic diagram showing a method of repairing a display device shown in FIG. 6.

Referring to FIGS. 6 and 9, when an M-th open defect E_{M} occurs in an M-th data line DL_{M} of the data lines formed in the display panel during a manufacturing process, a method for repairing the M-th data line DL_{M} is as follows.

A shorting process is performed, which electrically shorts to the M-th data line DL_{M} and the first repair line section 360, and the M-th data line DL_{M} and the second repair line section 370.

Particularly, a laser beam is applied in an overlapping portion between a first end portion of the M-th data line DL_{M} and the second repair line 362 to form a first shorting portion S1. A laser beam is applied in an overlapping portion between a second end portion of the M-th data line DL_{M} and the fourth repair line 372 to form a second shorting portion S2.

Then, in order to repair through the second dummy buffer section 640 adjacent to the M-th data line DL_{M} of the first dummy buffer sections 630 or the second dummy buffer section 640 formed in a left portion when viewed from a plan view of the display device, and the third dummy buffer 650 or the fourth dummy buffer 660 formed in a right portion when viewed from a plan view of the display device, a cutting process is performed as follows.

Particularly, a portion of the second repair line 362 is cut to form a first cutting portion C1, which electrically connects to the first shorting portion S1 and the second dummy buffer portion 650. The second repair line 362 and the third dummy buffer section 650 are electrically opened through the first cutting portion C1.

A portion of the fourth repair line 372 is cut to form a second cutting portion C2, which is formed between the first cutting portion C1 and the second shorting portion S2. The second shorting portion S2 and the third dummy buffer section 620 are electrically opened through the second cutting portion C2. The M-th data line DL_{M} is electrically connected to the second dummy buffer section 640 through the first and second shorting portions S1 and S2.

Then, the second dummy buffer 641 of the second dummy buffer section 640 is enabled, which is electrically connected to the second repair line 362 and the fourth repair line 372.

Particularly, the second control line 642 is cut to form a third cutting portion C3, which applies a driving voltage to the second dummy buffer 641. The second dummy buffer 641 is disabled when the driving voltage is applied thereto, and is enabled when the driving voltage is insulated therefrom.

As the driving voltage, which is applied to the second dummy buffer 641 through the second control line 642, is insulated through the third cutting portion C3, the second dummy buffer 641 is enabled. The data signal input through the second repair line 362 is amplified to a predetermined level in the second dummy buffer 641, and then the amplified data signal is output to the fourth repair line 372.

As a result, a data signal output from the second source driver chip IC2 is applied to the M-th data line DL_{M} formed in a relatively upper portion of the M-th open defect E_{M}. In the mean time, the data signal output from the second source driver chip IC2 is input to the second dummy buffer 641 through the first shorting portion S1 to amplify to a predetermined level, and then applied to the M-th data line DL_{M} formed in a relatively upper portion of the M-th open defect E_{M} through the fourth repair line 372 formed in the second peripheral area PA2 and the second shorting portion S2 formed in the fourth peripheral area PA4.

Therefore, the data signal may be regularly applied to the M-th data line DL_{M} having an open defect. According to the repairing method, a total number of four data lines may be repaired.

As described above, in the display device with the display panel having the source driver chip directly mounted thereon such as a chip on glass (COG) structure, the dummy buffer for repairing the data line may be built into the source driver chip, so that a line defect in the COG structure may be easily repaired.

Although the exemplary embodiments of the present invention have been described, it is understood that the present invention should not be limited to these exemplary embodiments but various changes and modifications can be made by one ordinary skilled in the art within the spirit and scope of the present invention as hereinafter claimed.

What is claimed is:

1. A driver chip for a display device, comprising:
an output buffer section outputting a data signal to a plurality of data lines formed in a display area of a display panel; and
a dummy buffer section being electrically connected to a repair section crossing an end portion of the data lines, the repair section being formed in a peripheral area surrounding the display area in a ring shape.

2. The driver chip of claim 1, wherein the repair section comprises:
a first repair line section being crossed with a first end portion of the data lines; and
a second repair line section being electrically connected to the first repair section through the dummy buffer section, the second repair section being crossed with a second end portion of the data lines.

3. The driver chip of claim 2, wherein the dummy buffer section comprises:
a dummy buffer having an input terminal electrically connected to the first repair line section and an output terminal electrically connected to the second repair line section;
an external terminal receiving a driving voltage; and
a power terminal being electrically connected to the external terminal through a control line formed in the peripheral area, the power terminal applying the driving voltage to the dummy buffer.

4. A display device comprising:
a display panel including a display area having a plurality of data lines and a plurality of gate lines crossing each other, and a peripheral area surrounding the display area;
a first dummy buffer section built into a first driver chip directly mounted in the peripheral area;
a first repair line section being crossed with a first end portion of the data lines, the first repair line section being electrically connected to the first dummy buffer section; and
a second repair line section being crossed with a second end portion of the data lines, the second repair line section being electrically connected to the first repair line section through the first dummy buffer section.

5. The display device of claim 4, wherein the first and second repair line sections with a ring shape are formed in the peripheral area to surround the display area.

6. The display device of claim 4, wherein the first repair line section comprises a first repair line and a second repair line, wherein the second repair line section comprises a third repair line and a fourth repair line being electrically connected to the first and second repair lines, respectively.

7. The display device of claim 6, wherein the first dummy buffer section comprises:
a first dummy buffer having a first input terminal electrically connected to the first repair line, and a first output terminal electrically connected to the third repair line, the first dummy buffer amplifying an input signal provided from the first input terminal and outputting the amplified signal to the first output terminal;
a second dummy buffer having a second input terminal electrically connected to the second repair line, and a second output terminal electrically connected to the fourth repair line, the second dummy buffer amplifying an input signal provided from the second input terminal and outputting the amplified signal to the second output terminal;
a first control line electrically connected to an external terminal applied in a driving voltage provided from an external device, and the first power terminal of the first dummy buffer; and
a second control line electrically connected to the external terminal and a second power terminal of the second dummy buffer.

8. The display device of claim 6, wherein the first dummy buffer section comprises:
a first dummy buffer including a first input terminal electrically connected to the first repair line, and a first output terminal electrically connected to the third repair line, the first dummy buffer amplifying the input signal through the first input terminal and outputting the amplified signal through the first output terminal; and
a first control line electrically connected to a first external terminal receiving a driving voltage from an external side and a first power terminal of the first dummy buffer.

9. The display device of claim 8, further comprising:
a second driver chip being mounted on the peripheral area adjacent to the first driver chip; and
a second dummy buffer section built into the second driver chip.

10. The display device of claim 9, wherein the second dummy buffer comprises:
a second dummy buffer including a second input terminal electrically connected to the second repair line, and a second output terminal electrically connected to the fourth repair line, the second dummy buffer amplifying the input signal through the second input terminal and outputting the amplified signal through the second output terminal; and
a second control line electrically connected to a second external terminal that receives the driving voltage and a second power terminal of the second dummy buffer.

11. The display device of claim 10, wherein a signal output from the second output terminal of the second dummy buffer is applied to the fourth repair line through the first dummy buffer section.

12. A display device comprising:
a display panel including a display area with a plurality of gate lines and a plurality of data lines crossed with each other, and a peripheral area that surrounds the display area;
a source driving part being directly mounted thereon, the source driving part including a plurality of driver chips that output data signals to the data lines:
a first repair line section being crossed with a first end portion of the data lines, the first repair line being electrically connected to a driver chip disposed at an end portion of the peripheral area; and
a second repair line section being electrically connected to the first repair line section through the driver chip, the second repair line section being crossed with a second end portion of the data lines.

13. The display device of claim 12, wherein the first and second repair line sections are formed in the peripheral area in a ring shape to surround the display area.

14. The display device of claim 13, wherein the first repair line section comprises a first repair line and a second repair line,
and the second repair line section comprises a third repair line and a fourth repair line that are electrically connected to the first and second repair lines, respectively.

15. The display device of claim 14, wherein the driver chip comprises a dummy buffer section, wherein the dummy buffer section comprises:
a first dummy buffer including a first input terminal electrically connected to the first repair line, and a first output terminal electrically connected to the third repair line, the first dummy buffer amplifying the input signal through the first input terminal and outputting the amplified signal through the first output terminal;
a second dummy buffer including a second input terminal electrically connected to the second repair line, and a second output terminal electrically connected to the fourth repair line, the second dummy buffer amplifying the input signal through the second input terminal and outputting the amplified signal through the second output terminal;
a first control line electrically connected to an external terminal receiving a driving voltage from an external side and a first power terminal of the first dummy buffer; and
a second control line electrically connected to the external terminal and a second power terminal of the second dummy buffer.

16. A display device comprising:
a display panel including a display area with a plurality of gate lines and a plurality of data lines crossed with each other, and a peripheral area that surrounds the display area;
a source driving part including a plurality of driver chips being directly mounted on the peripheral area, the driver chips outputting data signals to the data lines;
a first repair line section being crossed with a first end portion of the data lines, the first repair line being electrically connected to a first driver chip and a second driver chip of the driver chips, respectively, the first and second driver chips being disposed adjacent to each other; and
a second repair line section being electrically connected to the first repair line section through the first and second driver chips, the second repair line section being crossed with a second end portion of the data lines.

17. The display device of claim 16, wherein the first and second repair line section with a ring shape is formed in the peripheral area.

18. The display device of claim 17, wherein the first repair line section comprises a first repair line and a second repair line,
and the second repair line section comprises a third repair line and a fourth repair line that are electrically connected to the first and second repair lines, respectively.

19. The display device of claim 18, wherein the first driver chip comprises a first dummy buffer section, wherein the first dummy buffer section comprises:
a first dummy buffer including a first input terminal electrically connected to the first repair line, and a first output terminal electrically connected to the third repair line, the first dummy buffer amplifying the input signal through the first input terminal and outputting the amplified signal through the first output terminal; and
a first control line electrically connected to a first external terminal receiving a driving voltage from an external side and a first power terminal of the first dummy buffer.

20. The display device of claim 19, wherein the second driver chip comprises a second dummy buffer section, wherein the second dummy buffer section comprises:
a second dummy buffer including a second input terminal electrically connected to the second repair line, and a second output terminal electrically connected to the fourth repair line, the second dummy buffer amplifying the input signal through the second input terminal and outputting the amplified signal through the second output terminal; and
a second control line electrically connected to a second external terminal receiving the driving voltage and a second power terminal of the second dummy buffer.

21. The display device of claim 20, wherein a signal output from the second output terminal of the second dummy buffer is applied to the fourth repair line through the first dummy buffer section.

22. A method for repairing a display device, the method comprising:
forming a first shorting section by shorting a crossing portion between a first repair line and a first end portion of a defective data line, the first repair line being electrically connected to an input terminal of a dummy buffer built into a source driver chip directly mounted on a display panel;
forming a second shorting section by shorting a crossing portion between a second repair line electrically connected to an output terminal of the dummy buffer, and a second end portion of the defective data line; and
enabling driving of the dummy buffer.

23. The method of claim 22, further comprising:
forming a first cutting section by cutting a portion of the first repair line adjacent to the first shorting section; and
forming a second cutting section by cutting a portion of the second repair line formed between the first cutting section and the second cutting section.

24. The method of claim 23, wherein enabling driving of the dummy buffer includes forming a third cutting section by cutting a control line that applies driving voltage to a power terminal of the dummy buffer formed on the display panel.

25. The method of claim 24, wherein the dummy buffer is disabled when the driving voltage is applied thereto, and is enabled when the driving voltage is insulated therefrom.
